(19) United States
(12) Patent Application Publication
(10) Pub. No.: US 2004/0203854 A1
(43) Pub. Date: Oct. 14, 2004

(54) Formatting location information based on output device specifications

(76) Inventor: Steven P. Nowak, Superior, CO (US)

Correspondence Address: MARSH FISCHMANN & BREYFOGLE LLP/OPENWAVE SYSTEM, INC., 3151 SOUTH VAUGHN WAY, SUITE 411, AURORA, CO, 80014, US

(21) Appl. No.: 10/133,221

(22) Filed: Apr. 26, 2002

(51) Int. Cl. H04Q 7/20

(52) U.S. Cl. 455/456.1; 455/414.1

(57) ABSTRACT

In connection with a location-based service application of a wireless network, a presentation of location-based service information is determined based on a specification regarding a user system. In one implementation, a network platform (106) includes a processor for executing a local information application (108) that services users (102 and 104). The operation of the application (108) and delivery and presentation of output service information to the users (102 and 104) is controlled based on user system specification information such as mobile unit specification information. Such specifications may relate to limitations of the user equipment and associated output device. In particular, the content and format of the output information may be determined based on the specifications. In addition, the output information may be presented based on predefined field limitations and prioritization criteria defining a priority for information presentation.

### FIELD OF THE INVENTION

The present invention generally relates to location-based service applications for wireless networks and, in particular, to formatting or otherwise processing location information for improved service application operation and improved output presentation on an output device.

### BACKGROUND OF THE INVENTION

Location-based service applications generally involve providing information based on or otherwise relating to the locations of one or more mobile units such as wireless telephones, pagers, PDAs or wireless data terminals. The nature of the information provided and the output device vary from application-to-application and unit-to-unit.

Some examples illustrate this point. One type of location-based application is local service applications. In these applications, a subscriber can obtain information specific to the current locale of the subscriber by way of a request entered on or for a mobile unit. Examples of the kind of information that may be requested include local weather information, local traffic information, information about local restaurants, hotels, cash machines or other services, and information about events or points of interest. Such information is often provided to the mobile unit, e.g., for visual display on the handset or via audio messaging.

Another type of location-based service application is wireless unit locating applications. These applications enable a user to locate family, friends, employees and assets. For example, the locations of vehicles of a fleet may be tracked using wireless network location technologies to facilitate efficient fleet management. Such information may be provided to a desk-top or other land-line data terminal, or may be provided to a mobile unit.

Generally, the operations performed in connection with such applications involve determining the location of one or more mobile units, accessing a database or other source based on mobile unit location to collect the desired service information, and outputting the service information to the output device. Such service information may include, for example: the name and address, phone number, URL or other information for local service providers; location information for friends, family or employees within a given radius of the requesting unit or within the same locale or virtual “village” as the requesting unit; or graphical mapping information indicating the locations of mobile units, service providers or points of interest.

At least some of this functionality may be performed on one or more network platforms separate from the located mobile unit(s) such that communication is required between the mobile unit and the network across an air interface, e.g., for obtaining location information, receiving an information request and/or providing service information to the mobile unit. The use of one or more network platforms allows servers or other platforms to service many subscribers and facilitates access to current information and database administration. Additionally, network implementation allows for potential access to a variety of sources of location information, e.g., via a wireless network location gateway, for improved availability and, perhaps, accuracy and timeliness of location information. Network implementation also allows network providers or carriers to offer value added services to their subscriber base and can make location-based services available to a broad base of users, including users without GPS-enabled handsets or other specialized location equipment.

### SUMMARY OF THE INVENTION

It has been recognized that implementation of such applications is problematic, particularly via network platforms that may service many subscribers and multiple applications. In particular, the output modes and display capabilities of target user systems and their associated output devices vary considerably in the context of location-based service applications. For example, it may be desired to transmit the service information via telephony and/or data networks. Moreover, the display capabilities of the output device may vary considerably, e.g., from the full graphics capability of an Internet terminal with a full functionality web browser, to the more limited display area and capabilities of a PDA, to the still further limited display capabilities of a typical wireless telephone (with or without a microbrowser) or pager.

The present invention enables the use of specification information regarding a user system to optimize operation of location-based service applications as well as presentation (e.g., content selection/truncating and formatting) of location-based service information via an output device of a user system. In this regard, it will be appreciated that it would also be beneficial to optimize the information transmitted to the user system, particularly where a wireless interface is involved, to most efficiently use the available bandwidth. The present invention allows for such optimization in the location-based services context, which is often characterized by potentially rich content, narrow bandwidth (“pipes”), thin clients and the desire for rapid response with specifically targeted information. Certain conventional protocols including WAP provide browser specific display functions that can be utilized for optimized formatting of service information for location-based service applications in accordance with the present invention.

Aside from the bandwidth considerations, it will be appreciated that the optimal presentation of location information may vary depending on the characteristics of the user system including display capabilities (e.g., size and resolution), the display functionality of any browser or other display related logic, processing speed and resources, and the like. Such characteristics may affect the desired presentation of the output, including output mode (e.g., data, telephony, audio, visual, multimedia, color, gray scale, black and white, digital, analog, etc.), subject matter, ordering, pagination, organization, color and shading, scrolling features and other characteristics of the content and/or format of the output. Additionally, certain applications may be administered more efficiently by making use of certain information regarding the user system. For example, it may be unnecessary to access a mapping database if the target user system does not support the graphics required for presentation of maps. In this regard, the present invention allows for use of information regarding the user system, user preferences, or other specifications for processing service information in connection with location-based service applications for a wireless network.

According to one aspect of the present invention, a method is provided for employing user system specifications for processing a service request, e.g., to determine a presentation of location-based service information in connection with a location-based service application of a wireless network. In accordance with the inventive method, a processor is operative to receive a service request for a mobile unit, obtain location information for the mobile unit, and obtain location-based service information from a source that is separate from the user system, where the service information is responsive to the request and based on the location information. The processor is further operative for obtaining information regarding at least one specification of the user system or its operating environment and using the specification to process the service request such as to determine a presentation of the location-based service information. With regard to determining a presentation, the processor may select content based on the specification or may reformat the service information, based on the specification, from a first format of the information source to a second format dependent on the specification. In this manner, location-based service information can be selected or formatted on a user dependent basis, e.g., so as to optimize service application operation and/or presentation of the information at the user system. A corresponding apparatus of the present invention includes ports for receiving a location request and user specification information, and a processor for accessing and selecting or reformatting location-based service information.

The processor may be separate from the mobile unit and, in a preferred implementation, is interconnected to the mobile unit via an air interface. In this regard, the processor may be implemented in conjunction with one or more wireless network platforms executing the location-based services application or associated platforms, such as a location gateway, network register or the like, for supporting such applications. The service request may be entered by the mobile unit or other user (e.g., a fleet manager) and may be a one-time-only request, part of a repeating request, e.g., for periodic updates, or may be prompted by an event such as a boundary crossing. Preferably, the location information is available from one or more network-based or network assisted technologies such as cell ID, enhanced Cell ID, AOA, TDOA, A-GPS, E-OTD, TOA or TA in addition to any handset-based information, such as GPS information, that may be available for particular subscribers.

The location-based service information may be obtained from a variety of sources depending, for example, on the nature of the application. Thus, in the case of local information applications, service provider or other information may be obtained from databases of subscribing service providers or from a variety of web servers provisioning local information or other external sources. The service information may also be accessed from additional source applications such as map provisioning or other GIS applications. It will thus be appreciated that the obtained information may have a variety of contents and formats.

The user system specification information may identify any of a variety of information relevant to defining a format, output capability or other factor relevant to presentation of the location-based service information. For example, such information may directly or indirectly indicate an output device limitation of the user system output device (e.g., display area, pixels, colors) that may be used to limit the information made available for display or to determine lineage, pagination, organization and the like. Alternatively or additionally, such information may identify a browser or microbrowser of the user system such that appropriate or optimized display options can be selected. An additional example of such information is information relating to processor speeds and bandwidth availability. It will be appreciated that these items may be problematic in the context of location-based service applications due to the likelihood of rich content (e.g., graphical mapping information) combined with narrow pipes (e.g., crowded RF interfaces) and thin clients (e.g., some pagers and wireless phones) and the desire for rapid response.

In accordance with another aspect of the present invention, a specification for a mobile unit may be used to limit the amount of location-based content transmitted across an air interface. The associated method involves: providing a platform interconnected to the mobile unit via an air interface; obtaining, at the network platform, location-based service information content and at least one specification for the mobile unit; and operating a platform processor to selectively reduce an amount of the location-based information content made available for transmission across the air interface to the mobile unit based on the mobile unit specification. For example, such content may be made available in a text-only form, may be limited to certain fields of information for use in a given location-based services context or the number of responsive items may be reduced based on the mobile unit specification. In this manner, the content made available for transmission to the mobile unit can be reduced, thereby conserving limited bandwidth resources and improving effective response time.

In accordance with a further aspect of the present invention, a mobile unit specification is used in combination with one or more prioritization criteria to determine a presentation of location-based service information to a mobile unit. As noted above, there are a variety of reasons why it may be beneficial to process location-based service information based on mobile unit specifications. Such information can also be processed based on predefined prioritization criteria to further optimize presentation on the mobile unit. Such prioritization criteria may be specified by mobile subscribers, other application users, service providers, network operators or others. For example, a mobile subscriber may indicate a preference for receiving information regarding multiple service providers ordered for display based on proximity (e.g., closest-to-farthest), based on a stored profile of subscriber preferences (e.g., identifying preferred chains or characteristics relating to credit card acceptance, availability of no-smoking rooms/areas, frequent flyer or other promotional participation, etc.), or based on ease of access or by information category (e.g., specifying a preference for location weather information followed by a listing of local events). Alternatively, or additionally, a listing of service providers may be prioritized based on participation by the service providers in different promotional plans or levels offered by a carrier or network operator.

The associated process of the present invention involves: receiving a request to provide location-based service information to a mobile unit; obtaining location information for the mobile unit; using the location information to obtain location-based service information responsive to the request; accessing at least one mobile unit specification and at least one prioritization criterion; and using both the specification and the criterion to process the location-based service information so as to determine a presentation for at least part of the location-based service information to the mobile unit. In this manner, the mobile unit specification may be used, for example, to determine that only a given subset of the service information should be sent or should be presented on a “first page” of a display, and the prioritization criterion may be used to determine which information is sent or formatted for presentation on the first page.

According to a still further aspect of the present invention, a number of fields are defined specifically for location-based service information content and the fields are used to process information for presentation to a location-based service application user. For example, the fields may include: mobile unit identification, service provider identification, time of location determination, accuracy of location information, contact information, availability of on-line reservations/transaction processing, availability of secure financial information communication, availability of maps or driving instructions, etc. These fields can be used to filter information obtained and presented to a service application user such as a mobile subscriber or land-line terminal user. Such filtering may be executed on the user system and/or on a separate platform as may be preferred for wireless network applications.

The associated process involves: accessing stored information regarding predefined fields for location-based service information; obtaining input location-based service information responsive to a request in connection with a location-based service application and processing the input location-based service information to generate processed service information different than the input location-based service information, where at least one of the steps of obtaining and processing is based on predefined fields; and making at least some of the obtained service information available for presentation to the application user.

For example, in accordance with the present invention, a user (e.g., a mobile subscriber) may request the names, street addresses and phone numbers for the five (or other number of) closest hotels. This information may be communicated, in connection with XML tags, predefined bits/addresses of a defined message interface or the like identifying the associated fields, to a first network platform executing a hotel finder application. That platform may access a location gateway, invoke an appropriate system or otherwise obtain the location of the mobile unit. The first network platform may then access a database of service provider information or execute an appropriate data network search to obtain the requested information. The information retrieved may be limited to the identified fields or may be truncated using the identified fields so as to customize the output to the user based on the(in this case) field limited request.

### BRIEF DESCRIPTION OF THE DRAWINGS

For a more complete understanding of the present invention and further advantages thereof, reference is now made to the following Detailed Description, taken in conjunction with the drawings, in which:

FIG. 1 is a schematic diagram of a network environment implementing the present invention;

FIG. 2 is a flow chart illustrating a process implemented in conjunction with a user system according to the present invention;

FIG. 3 is a flow chart illustrating a process implemented in connection with a network platform in accordance with the present invention;

FIG. 4 illustrates an output displayed on a mobile unit in accordance with the present invention;

FIG. 5 illustrates an output displayed on an enhanced graphics display device in accordance with the present invention; and

FIG. 6 illustrates a service provider information file in accordance with the present invention.

### DETAILED DESCRIPTION

As discussed above, the present invention is directed to a method and apparatus for improving the presentation of location-based service information on an output device of a user system in connection with location-based service applications for wireless networks. The invention can be implemented in connection with a variety of different types of location-based service applications and in connection with a variety of network environments and architectures. In addition, such applications may provide an output to a variety of different kinds of devices including both wireless devices and wireline terminals. The output may be provided by data or telephony networks.

In the following description, for purposes of illustration, the invention is set forth in the context of a local information application executed on a wireless network platform for providing output to wireless devices such as wireless telephones, wireless GPS platforms, PDAs or the like as well as wireline terminals. The invention has particular advantages in this context as such network implementation facilitates access to current information and database administration, allows for potential access to a variety of sources of location information, and allows network providers or carriers to offer value added services to their subscriber base and make location-based services available to a broad base of users without specialized location equipment. It will be appreciated, however, that various aspects of the invention have broader applicability.

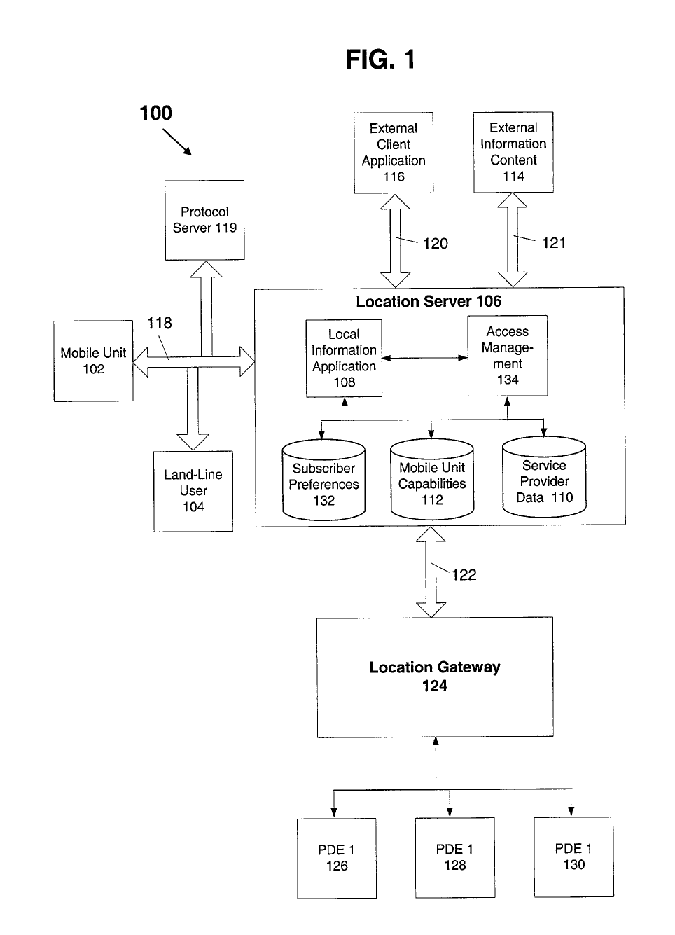

FIG. 1 illustrates a network environment 100 in which the present invention can be implemented. In particular, the environment 100 includes a network location server platform 106, including a processor for executing a local information application 108 that services subscribers/users 102 and 104. For example, such a local services application may provide information about local restaurants, hotels or other service providers or information about local weather, traffic conditions, events or other matters of interest based on a current location of an identified mobile user such as mobile unit 102. An example of such an application is described in Patent Cooperation Treaty Application No. 99/16414 by Hose, published on Jan. 27, 2002, which application is incorporated herein by reference in its entirety.

Many users with many different types of user systems may be serviced by application 108. Two users 102 and 104 are shown in FIG. 1 for purposes of illustration. In particular, user 102 is shown as including a mobile unit. For example, the mobile unit may be a wireless telephone, a pager, a wireless GPS platform or a PDA. Such a mobile user will generally communicate with the platform 106 by way of wireless network structure such as a cell site antenna and an MSC or SCP. It will be appreciated that such mobile units may communicate with the platform 106 in a telephony or data mode. In the case of a data-enabled phone or another wireless data terminal, a protocol server 119 such as a WAP server may be implemented in connection with the platform 106 or separately. Such protocol servers 119 perform a number of functions related to providing an interface between the wireless network and the Internet, such as accommodating wireless network latencies and filtering the graphics rich Internet content for more efficient transmission and display by the mobile unit 102. Many of these functions can be advantageously utilized in implementing the present invention. In any event, it will be appreciated that communications between the mobile unit 102 and the platform 106 involve at least one air interface, e.g., an RF communication channel.

FIG. 1 also shows a land-line user 104. It will be appreciated that various types of location-based service applications including local information application 108 may provide output to a land-line user 104. For example, a business traveler with a wireless telephone and a laptop computer may choose to access the application 108 using the laptop computer in order to utilize the richer graphics, potentially faster response times and potentially advantageous access rates. This may be accommodated by the application 108 provided that the associated access security rules are constructed to allow such access. In such a case, the laptop user may identify the mobile unit to be located (presumably, the user's mobile telephone) and the application 108 can then provide local content based on location information regarding the mobile unit.

The application 108 is operative for providing location specific information based on the current or recent location of the identified mobile unit, e.g., unit 102. Such information may be obtained in a variety of ways. For example, some mobile units include handset-based location equipment such as GPS units. In such cases, the mobile unit location may be provided in messages transmitted between the mobile unit 102 and the platform 106. It will be appreciated, however, that applications limited to use of such specialized handset equipment may be limited in terms of the available user base as well as geographic coverage, e.g., due to shadowing or so-called urban canyon effects. Accordingly, the illustrated network environment 100 is configured to allow the application 108 to access information from one or more of various Position Determination Equipment (PDE) 126, 128 and 130. Specifically, in the illustrated implementation, the platform 106 can obtain such information via location gateway 124. For purposes of illustration, the location gateway 124 is shown as being a separate functional unit, separate from platform 106. It will be appreciated, however, that the location gateway functionality may be implemented on platform 106 and may be executed as middleware of an integrated system.

The location gateway 124 is operative for collecting location information for identified subscribers from any of the PDEs 126, 128 and 130, storing recent location information in cache or other memory, and invoking the PDEs 126, 128 and 130 as necessary. The gateway 124 may further be operative for combining input from multiple PDEs 126, 128 and 130 to obtain more accurate or otherwise enhanced location information for a mobile unit. Such functionality is described in Patent Cooperation Treaty Application No. 99/25838 by Fitch, et al., published on May 11, 2000, which is incorporated herein by reference in its entirety. A preferred location gateway product is marketed by SignalSoft Corporation of Boulder, Colo. under the name “Location Manager”.

As noted above, one advantage of the illustrated environment 100 is the ability to access multiple PDEs 126, 128 and 130 for better coverage, accuracy, timeliness, or cost/resource options. The illustrated PDEs may include any of various handset-based, network overlay or other position equipment type such as GPS, Cell ID, Enhanced Cell ID, AOA, TDOA, A-GPS, E-OTD, TOA or TA. Preferably, the PDEs 126, 128 and 130 include one or more network assisted technologies.

The application 108 collects location-based service information based on the location of the mobile unit. The nature of such service information varies depending, for example, on the nature of the application. In the case of the illustrated local information application 108, the location-based service information may be, for example, local weather information, local traffic conditions, and/or information regarding local service providers, local events or other local items of interest. This information may be stored in a database on a platform 106 or be otherwise accessible from the platform 106 or may be gathered from external sources. In the illustrated implementation, a service provider database 110 is illustrated on platform 106. In this regard, a network operator may store a database of information regarding subscribing service providers. Depending on the service provider's business model, subscribers may be charged a fee to be included in the database and/or permission may be obtained from service providers before loading service provider information into the database 110. The illustrated application 108 also obtains information from external sources 114. It will be appreciated that many such sources of local information are available via the Internet. For example, weather information, local restaurant and hotel listings, local events and the like may be obtained from appropriate Internet links. Such information may be shared via industry alliances. Thus, in the illustrated embodiment, the external information sources 114 may be accessed by appropriate Internet links.

The application 108 may further make use of a variety of other external applications 116. For example, the application 108 may access a map server or other GIS application, for example, to convert latitude and longitude coordinates into street address information or vice versa, to obtain map images to output to the user 102 or 104 or to access delivery zone or other boundary information. Although such functionality is described in connection with an external application 116 separate from the platform 106, it will be appreciated that similar functionality may be provided as middleware of an integrated system or otherwise.

In accordance with the present invention, the operation of application 108 and delivery and presentation of output service information to the users 102 and 104 may be controlled based on certain user information such as mobile unit device capability information and subscriber preference information. Such specification information may identify any information relevant to the user or user equipment. In particular, it may be useful to provide information relating to capabilities or limitations of the user equipment and associated output device as well as limitations of the communications link between the user device and the platform 106. Such information may be provided on a transaction-by-transaction basis or may be stored in a database and indexed to the user. Thus, for example, a browser or microbrowser, connection speed or user device may be identified in connection with a particular location request. Such information may be explicitly entered by the user or transparently encoded into the associated messages. Alternatively, as shown, such information may be stored in a mobile unit device capabilities specification database 112 located on the platform 106 or otherwise accessible by a platform 106.

It will be appreciated that a variety of such specifications may be useful. One significant output device limitation in the context of mobile units is display size and resolution. In particular, for devices such as pagers and wireless telephones, the display area and the number of pixels may be very limited. Accordingly, a limited number of lines and characters may be usefully presented. Additionally, the ability to present graphics in such devices may be limited. Such limitations may relate to limited color or gray scale capabilities and/or limited graphics functionality of any associated microbrowser or other software for driving the display device. Furthermore, it may be desirable to provide a limited output content in order to facilitate fast response times. In the context of mobile units, two common limitations relate to narrow pipes and thin clients. Specifically, the processing speeds and resources of a mobile unit may be limited in relation to desktop computers or other land-line clients. With regard to bandwidth, the bandwidth available across the RF interface may be limited in relation to land-line clients. Even as between land-line clients, connection speeds may vary considerably. Accordingly, it may be desirable to significantly reduce the rich graphics content of certain web information in order to facilitate fast response times, particularly in the context of mobile units.

Such information or combinations thereof may be stored in the mobile unit specification database 112 and/or transmitted on a transaction-by-transaction basis in messages between the mobile unit and the platform 106. For example, the mobile unit specification database 112 may include specification files indexed to particular mobile units, e.g., indexed to the mobile unit's MIN/ESN. Such files may include information identifying the display size and resolution of the output device, identifying the microbrowser or other display logic, or any other specification information. As noted above, such information or additional information may be provided on a transaction-by-transaction basis. For example, an indication of download speeds may be obtained based on messages transmitted between the mobile unit 102 and platform 106. Relatedly, such bandwidth information may be monitored throughout the wireless network and stored, for example, on a cell-by-cell basis and updated periodically. Thus, bandwidth information may be applied based on current network conditions rather than on a user-by-user or transaction-by-transaction basis.

Although not shown in FIG. 1, similar information may be stored for land-line users. Such information may identify, for example, the user's connection speed, the types of output available on the user device (audio, video or multi-media), browser type and version, etc. Again, particular information such as the browser type may be available as part of the messaging between the user and the application platform.

To further facilitate efficient operation of the environment 100 and delivery of location-based service information, certain defined interfaces including defined location-based information fields may be provided. In the illustrated embodiment, such interfaces include interface 118 between the users 102 and 104 and the platform 106, interface 120 between the platform 106 and the external applications 116, interface 121 between the platform 106 and external content services 114 and interface 122 between the platform 106 and the location gateway 122. It will be appreciated that such defined interfaces may be used at other locations within the environment 100. These interfaces 118, 120 and 122 provide a defined message set, messaging protocol and information fields for requesting and delivering various types of information for implementing the local information application 108 as well as other types of location-based service applications. These interfaces 118, 120 and 122 facilitate both development of the various components and efficient operation. In this regard, developers of the user devices and associated logic, the external applications, and the location gateway 124 and application 108 can implement a variety of functionality based on the standard interface without the need to closely integrate development efforts with other developers. In operation, the interface allows the various components to customize requests and responses so as to most efficiently use environment resources.

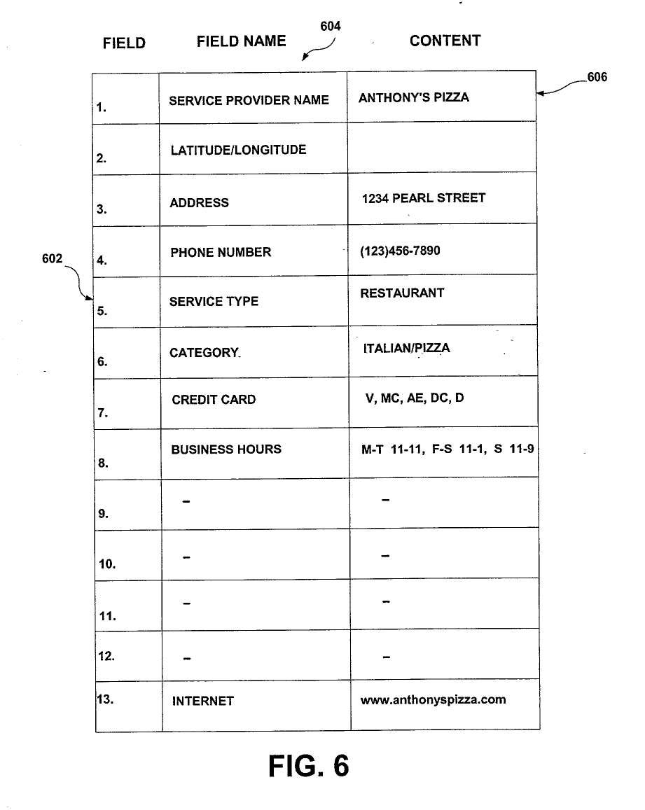

For example, FIG. 6 illustrates a file that may be stored in the service provider database 110. The file 600 is illustrated in table form including a first column 602 that identifies a field number, a second column 604 that identifies the field name and a third column 606 that identifies the field content. In this regard, each field that may be useful in providing location-based service information may be defined. For example, fields may be defined to identify accuracy of location information, the required timeliness of location information, specifications of the user system, characteristics of service providers, etc. In the context of the illustrated service provider file 600, a number of fields relevant to defining service provider information are shown. These fields include service provider name, the latitude and longitude of the service provider, the address of the service provider, the phone number of the service provider, the service type and category, information regarding credit card acceptance, business hours, etc.

Thus, for example, a user 102 or 104 may specify via the interface 118 particular fields of information that are desired. For example, mobile unit 102 may specify in connection with a request for information regarding local restaurants the service type (field 5) and category (field 6) of the restaurants to be identified, as well as specifying a desire to receive the service provider name (field 1), address (field 3) and phone number (field 4) of the identified restaurants. This information can be used both in defining the search for responsive service information and in defining the nature of the information displayed at the mobile unit 102, as will be discussed in more detail below. It will be appreciated that the user need not specify all of the desired fields in connection with each request. For example, a user may select a predefined format/content as part of an initial configuration process or on a transaction-by-transaction basis, from various predefined sets of display options that are associated with particular field combinations. Similarly, particular fields may be intrinsically associated with particular service requests. For example, a request for information about local pizza restaurants may be entered by keying in “*pizza” on the keyboard. Moreover, as will be discussed below, different display options may be implemented for different items responsive to an individual service information request.

Similar efficiencies may be obtained in connection with interfaces 120 and 121 between the platform 106 and the external applications 116 and content sources 114. For example, where the external application 116 is a GIS application operative for returning street address information based on geographical coordinates and for serving associated mapping graphics, the nature of the information requested and returned via the interface 120 may be tailored based on user specifications or preferences. Thus, where the user requests only address information or is otherwise incapable of displaying mapping graphics, the application 108 may request only address information corresponding to geographical coordinates and have such limited information returned via the interface 120. An example of an application where this may be desired would be a location-based service application for identifying the locations of family or friends. In such applications, a first mobile unit may request information regarding the location of a second mobile unit associated with a friend. Such location information may be obtained in terms of geographical coordinates from the location gateway 124. The external application 116 may be accessed to associate such geographical coordinate information with street address or similar network information. It will be appreciated that such information may be provided graphically or in text. Where the requesting mobile unit is incapable of displaying graphics, such information may be requested in terms of a text form, thereby conserving resources.

Such efficiency in operation of the environment 100 is further facilitated by interface 122. This interface 122 allows the application 108 to specify, for example, the mobile unit or units to be identified as well as any requirements regarding how timely and accurate the location information should be. In this manner, when a lower level of accuracy is tolerable (e.g., in connection with a request to identify which employees are in a particular city) a low resource PDE such as a Cell ID system may be invoked. Higher resource PDEs such as TDOA systems may be reserved for those instances where the associated accuracy is required. It will thus be appreciated that the standardized interfaces 118, 120 and 122 can be used to provide significant flexibility and efficiency in connection with requesting and providing the types of information useful for implementation of a variety of location-based service applications.

As noted above, it may be desirable to limit the amount of responsive content delivered to a user 102 or 104. Thus, for example, if a large number of restaurants are identified in response to a request, it may be useful to truncate the delivered service information to a subset of identified restaurants, or to deliver the full list in a format for sequential display on a series of display pages. In such cases, it may be useful to prioritize the output information. In this regard, associated prioritization criterion may be used to determine which information is presented, how much information is presented, in what order the information is presented and/or how prominently particular items of information are presented to the user. A variety of different types of prioritization information may be used in this regard. For example, items of responsive information may be prioritized based on how well they match the request. Thus, the responsive items may be prioritized on a closest-to-farthest basis, or on how well they match the request in terms of service type, category (subcategory, etc.). Alternatively, such prioritization information may relate to preferences defined by the application administrator, such as based on promotional programs that allow service providers to pay a premium in order to obtain a higher priority or prominence of display, such as is common in connection with phone directories.

The operation of the application 108 and delivery and presentation of output service information to the users 102 and 104 may further be controlled based on subscriber preferences. Associated subscriber preference information may be entered by the user or otherwise transmitted to the platform 106 on a transaction-by-transaction basis, or may be stored in a subscriber preferences database 132 on, or otherwise accessible from, the platform 106. Such preference information allows for identification of responsive service information or prioritization of such information for presentation to the user and display on the user's display device. Any relevant preferences of the user may be accommodated in this regard.

For example, in the context of a local service information application, a user may identify preferred service providers or chains for particular service categories (e.g., restaurants, hotels, etc.), identify preferred service parameters (availability of no smoking rooms, acceptance of pets, availability of network ports in rooms, availability of a children's menu, availability of a full bar, etc.), identify preferred business relationships (acceptance of credit cards, participation in frequent flyer or other promotional programs, etc.), or proximity to other facilities (restaurants, hotels, ATM machines, highways, etc.). In the latter regard, it will be appreciated that the application 108 may process compound service requests, e.g., to identify a hotel and fitness center or a restaurant and a movie theater that are mutually proximate to the user, or proximate to one another, and may iteratively access databases (e.g., 110 and 132), location gateway 124 and/or external resources (e.g., 114 and 116) in processing such compound requests.

An access management module 134 may also be implemented on or in connection with the platform 106. This module 134 can be used to ensure subscriber privacy, authenticate application clients, support various billing models for access to the applications/systems and otherwise address system management, security and housekeeping issues. The access management module 134 is particularly advantageous in managing access between subscribers and multiple third part applications and may be implemented in a variety of different architectures and in connection with various network platforms depending on the specific network implementation.

This preference information may be used together with information regarding specifications of the user device or preferences to determine the content and/or format of output information. For example, the user device specifications or preferences may be used to determine how many information items should be output or how many such items should be formatted into a display page, and the prioritization information may be used to determine which items should be output or presented on a first page, second page, etc., and how prominently such items should be presented.

In the case of a data enabled mobile unit, the responsive service information may be transmitted to the mobile unit via a protocol server 119 such as a WAP server. The protocol server is operative for interfacing the mobile unit with an internet protocol network and may further format the output information, for example, based on any microbrowser of the mobile unit. Thus, in the context of the present invention, the application 108 may determine the content of the output information and certain elements of format, e.g., relating to order and prominence of presentation, lineage, pagination, etc., and the server 119 may implement such format elements and further format the output information based, for example, on browser specific display options.

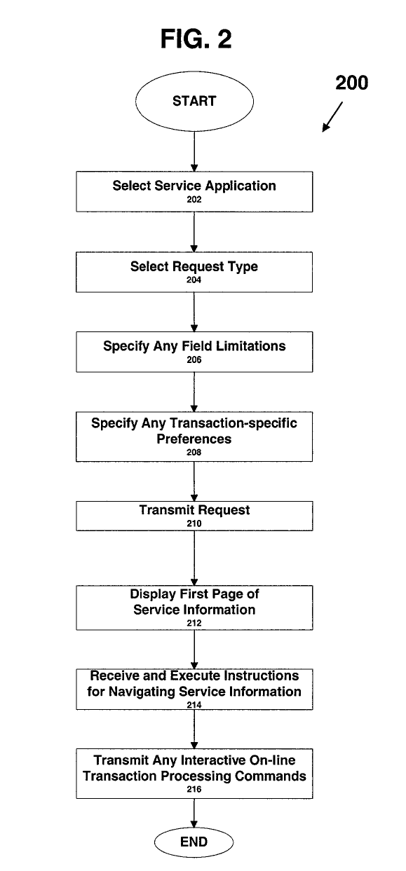

FIG. 2 is a flow chart illustrating implementation of a location-based service application from the user's perspective in accordance with the present invention. The process 200 is initiated by selecting (202) a service application. For example, the user may select a local service application from a menu displayed on the user device. The user can then select (204) a request type. In the context of a local service application, this may involve entering a request to identify local restaurants or local restaurants of a particular type. It will be appreciated that certain shortcuts may allow steps 202 and 204 (and other steps) to be collapsed into a single entry such as by keying in “*pizza”.

The user may also specify (206) any field limitations. As noted above, this may be conducted as part of a set-up process, for example, upon initially subscribing to the service associated with the application. Alternatively, such information may be specified on a transaction-by-transaction basis. In the latter regard, the user may select a predefined field set from a menu of options. One such option may be identified, for example, as “text-only—short form.”

The user may further specify (208) any preferences. As noted above, a variety of user preferences may be stored in a database associated with the application. Such information may be stored upon subscription and periodically updated. Additionally, such preferences may be entered on a transaction-by-transaction basis such as by requesting that responsive information be displayed on a closest-to-farthest basis. Any other appropriate preferences may be entered on a transaction-by-transaction basis. The service request may then be transmitted (210), for example, by pressing an “Enter” button or clicking on an appropriate icon. In the illustrated implementation, the request is then processed on a platform separate from the mobile unit.

Once such processing is complete and responsive service information is returned to the user, the information is displayed (212) on the user device. Where multiple pages of information are returned, an initial page may be displayed first with appropriate links to additional pages where appropriate. The user device can then receive and execute (214) instructions for navigating service information. In this regard, the information displayed on an initial page may include links to additional information or the user interface of the user device may be used to browse through the information. The user device may further be used to transmit (216) any interactive online transaction processing commands. Thus, for example, a call button on a wireless telephone may be used for one-button calling to an identified service provider. In the context of a data network, an appropriate link may be used to establish a data connection with an identified service provider. For example, such a link may be used to display a menu of an identified restaurant on the user device. Further interactive functionality, such as making reservations or purchases online may be supported. In the latter regard, credit card information or other secure financial information may be stored on the platform 106 or another network platform or transmission via a secure link to the service provider in order to consummate such an online transaction.

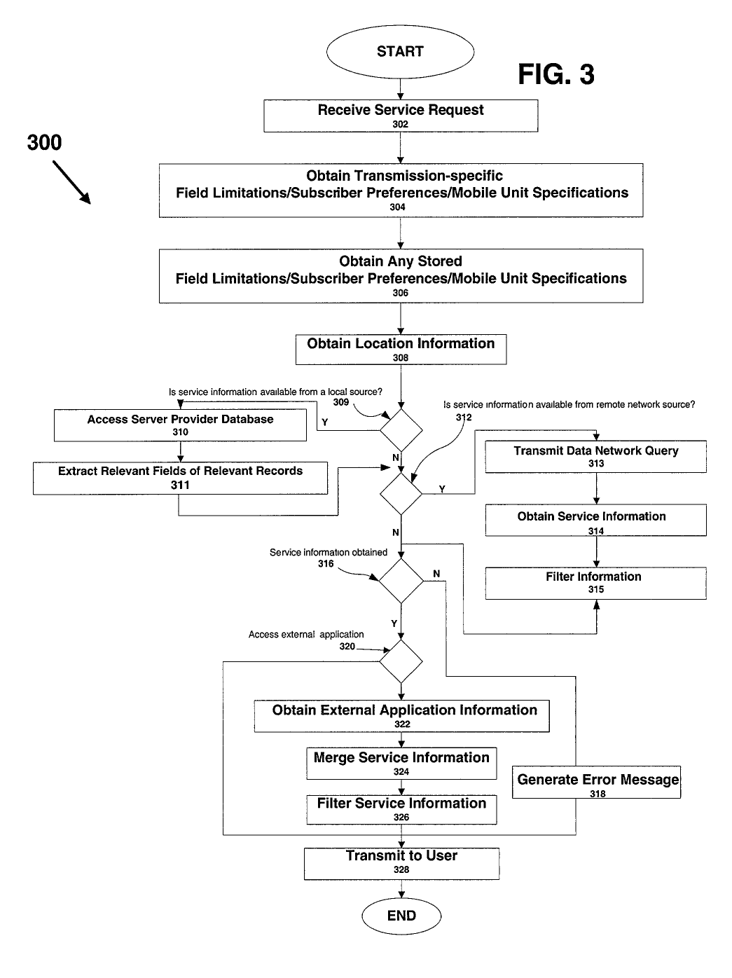

FIG. 3 illustrates a process 300 for implementing a location-based service application according to the present invention from the perspective of a network platform separate from a user device. The process 300 is initiated by receiving (302) a service request. Such a service request may identify a particular mobile unit and the type of service information that is desired. The application is then operative for obtaining (304) any transaction-specific field limitations, subscriber preferences and mobile unit specifications. Such field limitations may define the type of information requested and specify the fields of information that are to be returned to the user. The preferences may specify, for example, that the requested location information is to be prioritized on the basis of proximity, e.g., listing the closest service provider first. Other types of preferences that may be specified may include identifying only those service providers that accept Visa, or who participate in a specified frequent flyer promotional program. The specifications may identify particular limitations or characteristics of the user device such as display size and resolution and microbrowser type. Such information may be explicitly entered by the user or encoded (e.g., transparently from the perspective of the user) into messages transmitted between the user device and the application platform. Alternatively or additionally, such information may be obtained (306) from storage, e.g., from databases maintained on a network platform.

The application is then operative for obtaining (308) location information for the identified mobile unit. The identified mobile unit may be associated with the party requesting the information or another party. Depending on the specific implementation, the location information may be obtained directly from the application platform and/or may be requested from a location gateway or other platform within the network. In other cases, the location information may be transmitted to the application platform from the requesting mobile unit, e.g., where the mobile unit includes handset-based location equipment.

In the context of a local information application, service provider information may then be obtained from a local service provider database and/or by accessing remote web-based or other third party resources. Accordingly, in the illustrated implementation a determination (309) is first made as to whether responsive service information is available from a local service. If so, the associated database is accessed (310) and relevant information may be extracted (311) therefrom. In the illustrated implementation, a search tool associated with the database may be used to extract only relevant fields of relevant entries. For example, this may be implemented in connection with a conventional relational database tool.

A further determination (312) is then made as to whether to access remote network resources. If so, the application platform is operated to transmit (313) a data network query. For example, links may be established to appropriate web repositories based on the location information. The responsive information is then obtained (314) by the application platform and may be filtered (315) to extract only the service information desired by the user. Alternatively, as discussed above, an appropriate interface may be provided between the application platform and the external source such that the application platform can request and receive only the desired information. Where such an interface is not available, the filtering function is used to extract the relevant information. It will be appreciated that such relevant information may be identified based on XML tags or other identifying information contained within structured data. Such tags may be associated with the predefined fields of the location-based service operating environment. If no responsive service information is available from local or remote sources (316) an error message is generated (318) and transmitted (328) to the user.

As noted above, it may be further desired to access an external application such as a GIS application to obtain enhanced information for presentation to the user. In the illustrated implementation, a determination (320) is made whether to access such an external application. For example, such a determination may be made based on the specifications of the user output device, preferences of the user, or field limitations relating to the desired location-based service information. If it is not desired to access the external application, the process proceeds to transmit (328) the location-based service information to the user. If access to an external application is desired, the external application is accessed to obtain (322) the external service information such as address information or mapping graphics. This information is then merged (324) with the service information obtained from the database or network as described above (or may be separately transmitted and merged on the user device). For example, a marker identifying the location of a service provider or mobile unit may be associated with mapping graphics to provide location information. Other information such as a service provider name and phone number may be superimposed on the mapping graphics as displayed to user.

At this point, it may be necessary to filter (326) the location-based service information to be delivered to the user. For example, where address information and associated graphics are returned by the external application, and where such information is not supported or desired by the user output device, a portion of the information, such as the graphics, may be filtered from the location-based service information prior to transmittal to the user. Alternatively, as discussed above, where a defined interface is provided between the third party application and the application platform, the application platform may request and receive only the desired fields of information. Thus, the filtering function is effectively executed preemptively by the service application platform. In any case, the desired location-based service information can then be transmitted (328) to the user. It will be appreciated that, in this manner, only the desired information needs to be transmitted to the user, thereby conserving bandwidth as may be particularly important in connection with administration of wireless networks.

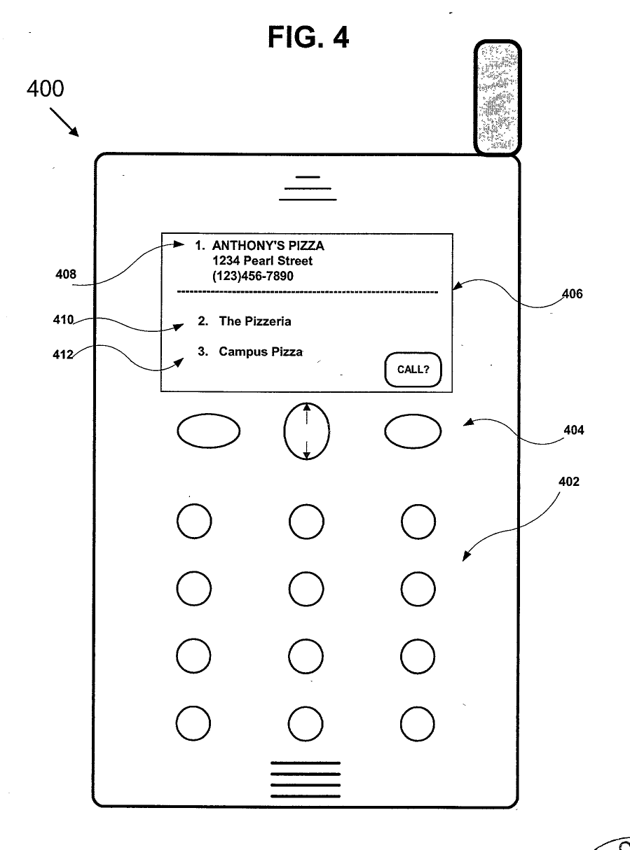

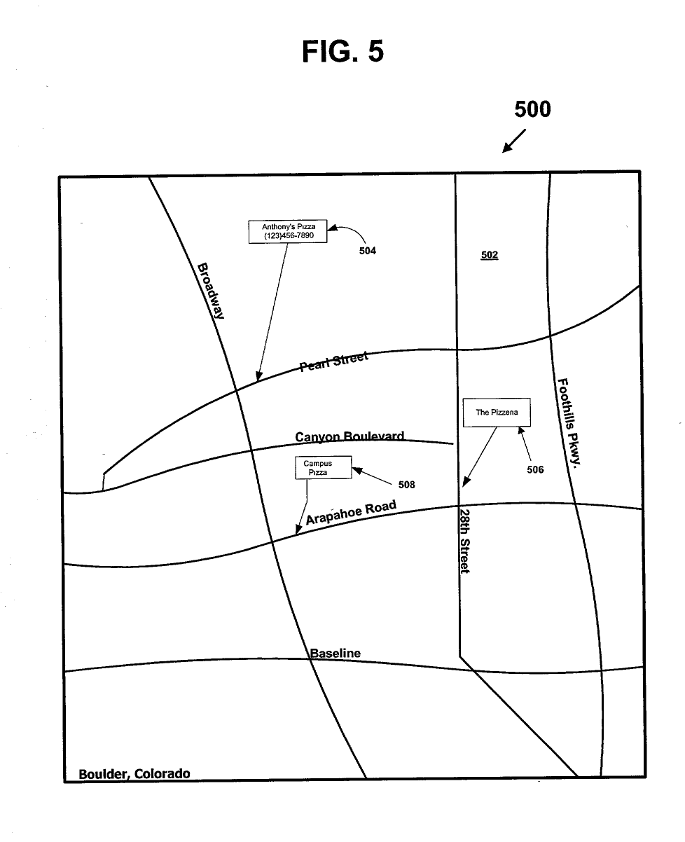

FIGS. 4 and 5 illustrate the provision of different contents and formats in connection with the present invention. In particular, FIG. 4 illustrates a limited display capability wireless device 400. The device 400 includes a limited number of keys for user inputs and a limited number of additional control keys 404 for entering information relative to the display area 406. In the illustrated example, service information regarding local pizza restaurants is displayed in display area 406. This information includes three entries 408, 410 and 412. As shown, the first entry 408 is displayed first, more prominently, and with more fields of information than the second entry 410 and third entry 412. This may be based on any appropriate prioritization criteria such as proximity or user preferences. It will be appreciated that additional entries may be provided on subsequent pages. Additionally, by highlighting one of the entries and entering an appropriate input such as pressing an “Enter” button, more detailed information regarding a particular service provider may be accessed. Moreover, as shown, when a desired input is selected (as indicated by shading) additional functionality may be provided such as a one-button function for calling the identified service provider. FIG. 5 shows another display area 500 that may be associated with a user device having greater graphics capability such as a desktop unit or certain PDAs. In the illustrated example, the display area 500 is used to display service information generally corresponding to that of FIG. 4 but with a different format and content. In particular, the service information is displayed together with a graphical map of the relevant geographical area. Such mapping information may be stored on the user device or may be obtained from an external application as discussed above. In the illustrated example, the locations of the identified service providers are shown graphically together with pop-up boxes giving name and, in one case, contact information. The associated logic of the user device or application may be used to provide additional information regarding the service providers by clicking on the pop-up boxes or by any other appropriate means.

While various embodiments of the present invention have been described in detail, it is apparent that further modifications and adaptations of the invention will occur to those skilled in the art. However, it is to be expressly understood that such modifications and adaptations are within the spirit and scope of the present invention.

What is claimed is:

1. A method for use in providing location-based service information for a mobile unit, comprising the steps of:
providing a location-based services application for obtaining location-based service information using location information regarding a location of said mobile unit;
first operating said location-based services application to receive a service information request regarding said mobile unit;
second operating said location-based services application to obtain operating environment information including one or more specifications regarding an operating environment of a service application user; and
third operating said location-based services application to process said service information request using said operating environment information, wherein said location-based services application provides responsive service information to said service application user that is responsive to said service information request and based on said location information regarding said location of said mobile unit.

2. A method as set forth in claim 1, wherein said step of providing a location-based services application comprises executing said application on a platform of a wireless network.

3. A method as set forth in claim 1, wherein said step of first operating comprises receiving said request from said mobile unit.

4. A method as set forth in claim 1, wherein said step of second operating comprises using identification information for said service application user to access memory to retrieve said operating environment information.

5. A method as set forth in claim 1, wherein said step of second operating comprises obtaining said operating environment information based on communications associated with said service information request.

6. A method as set forth in claim 1, wherein said step of second operating comprises obtaining said operating environment information based on a location of said service application user.

7. A method as set forth in claim 1, wherein said step of third operating comprises using said operating environment information to obtain said service information.

8. A method as set forth in claim 1, wherein said step of third operating comprises using said operating environment information to determine a presentation of said service information to said service application user.

9. A method as set forth in claim 1, wherein said step of third operating comprises using said operating environment information to determine a content of said service information output to said service application user.

10. A method as set forth in claim 1, wherein said step of third operating comprises using said operating environment information to determine a format of said service information output to said service application user.

11. A method as set forth in claim 1, wherein said step of third operating comprises processing said service information based on a display device limitation of said service application user.

12. A method as set forth in claim 1, wherein said step of third operating comprises processing said service information based on a browser specification of said service application user.

13. A method as set forth in claim 1, wherein said step of third operating comprises processing said service information based on one of a bandwidth limitation and processing speed limitation of said service application user.

14. A method as set forth in claim 1, further comprising the step of outputting said responsive service information to said service application user.

15. A method as set forth in claim 14, wherein said step of outputting comprises transmitting said information to said service application user via an air interface.

16. A method as set forth in claim 14, wherein said step of outputting comprises transmitting said information to said service application user via a platform for interfacing mobile units with the Internet.

17. A method as set forth in claim 1, wherein said step of second operating comprises receiving a data field limitation for said responsive service information.

18. A method as set forth in claim 17, wherein said data field limitation is based on information entered by said service application user.

19. A method as set forth in claim 1, wherein said step of third operating comprises obtaining first service information based on said service information request and selectively reducing said first service information to provide said responsive service information.

20. A method as set forth in claim 19, wherein said first service information includes an information item having a number of information fields and said step of selectively reducing comprises filtering at least one field from said information item.

21. A method as set forth in claim 19, wherein said first service information includes a number of information items and said step of selectively reducing comprises selecting a subset of said items for provision to said service application user.

22. A method as set forth in claim 21, wherein said step of selecting comprises analyzing said number of information items relative to at least one prioritization criterion defining a priority for presentation of said responsive service information to said service application user.

23. A method as set forth in claim 1, further comprising fourth operating said location-based service application to process said service information request based on at least one prioritization criterion defining a priority for presentation of said responsive service information to said service application user.

24. A method as set forth in claim 1, wherein said step of first operating is conducted prior to said step of second operating and said step of second operating is conducted prior to said step of third operating.

25. A method for use in providing location-based service information for a mobile unit, comprising the steps of:
providing a processing system for communication with said mobile unit across an air interface;
receiving, using said processing system, a query requesting delivery of location-based service information to said mobile unit;
first obtaining, using said processing system, location information regarding a location of said mobile unit;
based on said query and said location information, second obtaining, using said processing system, first location-based service information including one or more information items responsive to said query;
third obtaining, using said processing system, operating environment information including one or more mobile unit specifications regarding one or more functional characteristics of said mobile unit; and
operating said processing system to use said mobile unit specifications to select portions of said service information for transmission across said air interface to said mobile unit, wherein subset information less than the whole of said service information is transmitted across said air interface.

26. A method as set forth in claim 25, wherein said step of operating comprises selecting said portions of said service information based on a display device limitation of said mobile unit.

27. A method as set forth in claim 25, wherein said step of operating comprises selecting said portions of said service information based on a browser specification of said mobile unit.

28. A method as set forth in claim 25, wherein said step of operating comprises selecting said portions of said service information based on one of a bandwidth limitation and a processing speed limitation on said mobile unit.

29. A method as set forth in claim 25, further comprising the step of outputting said selected portions of said service information to said mobile unit via a platform for interfacing said mobile unit with the Internet.

30. A method as set forth in claim 25, wherein said service information includes a first information item having a number of information fields and said step of selecting portions of said service information comprises filtering at least one field from said first information item.

31. A method as set forth in claim 25, wherein said service information includes a number of information items and said step of selectin g portions of said service information comprises selecting a subset of said number of items.

32. A method as set forth in claim 25, wherein said step of operating further comprises using at least one prioritization criterion defining a priority for presentation of said service information to select said portions of said service information.

33. A method for use in providing location-based service information for a mobile unit, comprising the steps of:
first obtaining location information regarding a location of said mobile unit;
second obtaining service information content based on said location information;
third obtaining output device information including one or more mobile unit specifications regarding characteristics of said mobile unit;
based on said mobile unit specifications, selecting a subset of said service content less than the whole of said content, for presentation to said mobile unit; and
outputting said subset of said service content to said mobile unit.

34. A method as set forth in claim 33, wherein said step of selecting comprises selecting said subset based on a display device limitation of said mobile unit.

35. A method as set forth in claim 33, wherein said service content includes an information item having a number of information fields and said step of selecting a subset comprises filtering at least one field from said information item.

36. A method as set forth in claim 33, wherein said service content includes a number of information items and said step of selecting a subset comprises selecting a subset of said items.

37. A method as set forth in claim 33, wherein said step of selecting a subset comprises analyzing said service content relative to at least one prioritization criterion defining a priority for presentation of said service content to said mobile unit.

38. A method as set forth in claim 33, wherein said step of first obtaining comprises obtaining network assisted location information based at least in part on a location of said mobile unit relative to a stationary ground based structure in communication with said wireless unit via an air interface.

39. A method for use in providing location-based service information for a mobile unit, comprising the steps of:
first obtaining location information regarding a location of said mobile unit;
second obtaining service information including one or more information items of potential interest to a subscriber associated with said mobile unit based on said location information;
third obtaining output device information including one or more mobile unit specifications regarding one or more functional characteristics of said mobile unit;
accessing prioritization information relating to a priority for presenting said service information to said subscriber;
using said mobile unit specifications and said prioritization criteria to determine one of a format and a content of output service information; and
outputting said output service information to said mobile unit.

40. A method as set forth in claim 33, wherein said step of selecting comprises selecting said subset based on a display device limitation of said mobile unit.

41. A method as set forth in claim 33, wherein said service content includes an information item having a number of information fields and said step of selecting a subset comprises filtering at least one field from said information item.

42. A method as set forth in claim 33, wherein said service content includes a number of information items and said step of selecting a subset comprises selecting a subset of said items.

43. A method as set forth in claim 33, wherein said step of first obtaining comprises obtaining network assisted location information based at least in part on a location of said mobile unit relative to a stationary ground based structure in communication with said wireless unit via an air interface.

44. A method for use in providing location-based service information for a mobile unit, comprising the steps of:
defining a number of fields for one of requesting and providing service information in connection with a location-based services application;
first obtaining location-based service information based on a location of said mobile unit;
second obtaining operating environment information including one or more specifications regarding an operating environment of a service application user; and
using said defined fields and said operating environment information to process said location-based service information for presentation to said service application user.

45. A method as set forth in claim 44, wherein said step of first obtaining comprises obtaining network assisted location information based at least in part on a location of said mobile unit relative to a stationary ground based structure in communication with said wireless unit via an air interface.

46. A method as set forth in claim 44, wherein said location-based service information includes an information item having information corresponding to a number of said defined fields and said step of using said defined fields comprises filtering at least one field of information from said information item.

47. A method as set forth in claim 44, further comprising the step of processing said location-based service information based on at least one prioritization criterion defining a priority for presentation of said location-based service information to said application user.

48. A method for use in providing location-based service information for a mobile unit, comprising the steps of:
providing, to a location-based services application, mobile unit information regarding one or more specifications for said mobile unit relating to a presentation of an output from said location-based services application, said application being operative for obtaining location-based service information using location information regarding a location of said mobile unit;
first using said mobile unit to select a function associated with said location-based services application and transmit a request for requested location-based service information related to said selected function;
second using said mobile unit to receive customized location-based service information, said customized location-based service information being responsive to said request and having a custom output presentation that is based on said mobile unit specifications.

49. A method as set forth in claim 48, wherein said step of providing mobile unit information comprises providing a display device limitation of said mobile unit.

50. A method as set forth in claim 48, wherein said step of providing mobile unit information comprises entering information using said mobile unit.

51. An apparatus for use in providing location-based service information to a mobile unit, comprising:
a port for receiving a query requesting location-based information based on a location of said mobile unit;
logic for accessing location information regarding a location of said mobile unit and obtaining service information based on said location information;
memory for storing output device information including one or more specifications regarding characteristics of an output device of a location-based service information recipient; and
logic for using said specifications to determine a presentation of said service information to said recipient via said output device, thereby generating processed service information, and outputting said processed service information to said output device.

52. An apparatus as set forth in claim 51, wherein said port is operative for receiving communications transmitted via a wireless network.

53. An apparatus as set forth in claim 51, wherein said logic for accessing is operative for communicating with a location gateway of a wireless network.

54. An apparatus as set forth in claim 51, wherein said logic for using is operative for selecting one of a content and a format of said service information based on said specifications.
